(19) United States
(12) Patent Application Publication
(10) Pub. No.: US 2021/0233082 A1
(43) Pub. Date: Jul. 29, 2021

(54) FRAUD DETECTION VIA INCREMENTAL FRAUD MODELING

(71) Applicant: Walmart Apollo, LLC, Bentonville, AR (US)

(72) Inventors: Saurabh Vivek GAGPALLIWAR, Sunnyvale, CA (US); Jing Xia, Dublin, CA (US); Premalatha THANGAMANI, Fremont, CA (US); Kirti PANDE, Sunnyvale, CA (US); Suyog Ramesh CHOUDHARI, Fremont, CA (US)

(21) Appl. No.: 16/774,512

(22) Filed: Jan. 28, 2020

(51) Int. Cl. G06Q 20/40; G06N 7/00; G06N 20/20

(52) U.S. Cl. CPC G06Q 20/4016; G06N 20/20; G06N 7/00

(57) ABSTRACT

An approach is disclosed for identifying fraudulent transactions. The approach receives transaction order data for a transaction order. The approach applies a fraud model to the received transaction order data and generates an initial score. The approach determines whether to tentatively accept the received transaction order based on the generated initial score being less than a first threshold value. The approach applies, in response to tentatively accepting the received transaction order, an incremental fraud model to the received transaction order data and generates a second score. The approach denies the received transaction order when the second score is greater than a second threshold value.

### TECHNICAL FIELD

The disclosure relates generally to fraud detection, and more particularly, to identifying fraudulent transactions.

### BACKGROUND

When an e-commerce website receives an order to purchase a product listed for sale, the e-commerce website may analyze the order to determine whether the order is fraudulent. For example, the e-commerce website may determine that a fraudulent transaction occurs when an order for a product was placed using an impermissibly obtained credit card number and identification (ID) of a person or entity. This type of transaction and other types of fraudulent transactions may cause financial harm to the individual or entity who had their credit card numbers and IDs impermissibly obtained, as well as to the company who is selling the product. For instance, this individual may be unable to recover the money that was fraudulently transferred. In another instance, in an attempt to keep the individual's business, the company may reimburse the individual for the fraudulent payment transfer; however, the company may be left with a financial loss for the transaction. Additionally, the company may incur legal fees and reputational harm in connection with the fraudulent payment transfer.

To analyze the order, the e-commerce website may provide the order to a conventional fraud modeling system, which outputs a score for the order. Typically, the score indicates whether the e-commerce website should accept the order and process the transaction; deny the order and not process the transaction; or challenge the order, in which the company contacts the person identified as placing the order to verify that this person actually placed the order. Conventional fraud modeling systems may output a score for the order based on either proactive or reactive design. That is, for a proactive conventional fraud modeling system, the proactive system trains a model based previously acquired non-fraudulent transaction samples and fraudulent transaction samples. For a reactive conventional fraud modeling system, the reactive system analyzes non-fraudulent and fraudulent transaction samples to detect a fraud trend, and then implements a rule based on the detected fraud trend.

In either type of system, the systems determine whether a transaction sample is fraudulent based on whether a chargeback occurred for the corresponding transaction. A chargeback may be a return of money to the person identified with the credit card number. However, as chargebacks typically take several months (e.g., about five to six months) to complete, these systems have to wait to receive completed chargebacks before training models, analyzing fraud trends, and/or refreshing the models. If the systems used transaction samples before a potential chargeback matures, these transaction samples would incorrectly indicate that the transaction was a valid transaction, i.e., non-fraudulent. However, waiting for the completed chargebacks delays the supervised learning for these systems. Moreover, the systems may miss recent fraud trends happening due to external events, such as data breaches outside of the e-commerce website, bad actors making new credit card numbers and IDs available on the dark web, a product promotion that may increase bad user activity on the e-commerce website, and the like.

### SUMMARY

The summary of the disclosure is given to aid understanding of identifying fraudulent transactions, and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, devices, and their methods of operation to achieve different effects. Certain aspects of the present disclosure provide a system, method, and non-transitory computer readable medium for identifying fraudulent transactions.

In one or more aspects, the disclosed technology relates to a system that comprises a memory having instructions stored thereon, and a processor configured to read the instructions. In one or more cases, the processor is configured to read the instructions to receive transaction order data for a transaction order. In one or more cases, the processor is configured to read the instructions to apply a fraud model to the received transaction order data and generate an initial score. In one or more cases, the processor is configured to read the instructions to determine whether to tentatively accept the received transaction order based on the generated initial score being less than a first threshold value. In one or more cases, the processor is configured to read the instructions to apply, in response to tentatively accepting the received transaction order, an incremental fraud model to the received transaction order data and generate a second score. In one or more cases, the processor is configured to read the instructions to deny the received transaction order when the second score is greater than a second threshold value.

In one or more other aspects, the disclosed technology relates to a method. In one or more cases, the method comprises receiving transaction order data for a transaction order. In one or more cases, the method comprises applying a fraud model to the received transaction order data and generating an initial score. In one or more cases, the method comprises determining whether to tentatively accept the received transaction order based on the generated initial score being less than a first threshold value. In one or more cases, the method comprises applying, in response to tentatively accepting the received transaction order, an incremental fraud model to the received transaction order data and generating a second score. In one or more cases, the method comprises denying the received transaction order when the second score is greater than a second threshold value.

In yet one or more other aspects, the disclosed technology relates to a computer program product. In one or more cases, the computer program product comprises a non-transitory computer readable medium having program instructions stored thereon. In one or more cases, the program instructions may be executable by one or more processors. In one or more cases, the program instructions comprise receiving transaction order data for a transaction order. In one or more cases, the program instructions comprise applying a fraud model to the received transaction order data and generating an initial score. In one or more cases, the program instructions comprise determining whether to tentatively accept the received transaction order based on the generated initial score being less than a first threshold value. In one or more cases, the program instructions comprise applying, in response to tentatively accepting the received transaction order, an incremental fraud model to the received transaction order data and generating a second score. In one or more cases, the program instructions comprise denying the received transaction order when the second score is greater than a second threshold value.

### BRIEF DESCRIPTION OF THE DRAWINGS

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1 is a functional block diagram of a data processing environment, in accordance with one or more embodiments.

FIG. 2 is a functional block diagram illustrating components of the data processing environment of FIG. 1, in accordance with one or more embodiments.

FIG. 3 is a flowchart illustrating a process of identifying fraudulent transactions, in accordance with one or more embodiments.

FIG. 4A and FIG. 4B illustrates example distribution graphs for collected sample data.

FIG. 5 depicts a block diagram of components of a computing device capable of performing the processes described herein, in accordance with one or more embodiments.

### DETAILED DESCRIPTION

The following discussion omits or only briefly describes conventional features of the data processing environment, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Embodiments of the disclosure relate generally to fraud detection, and more particularly, to identifying fraudulent transactions. Embodiments that identify fraudulent transactions are described below with reference to the figures.

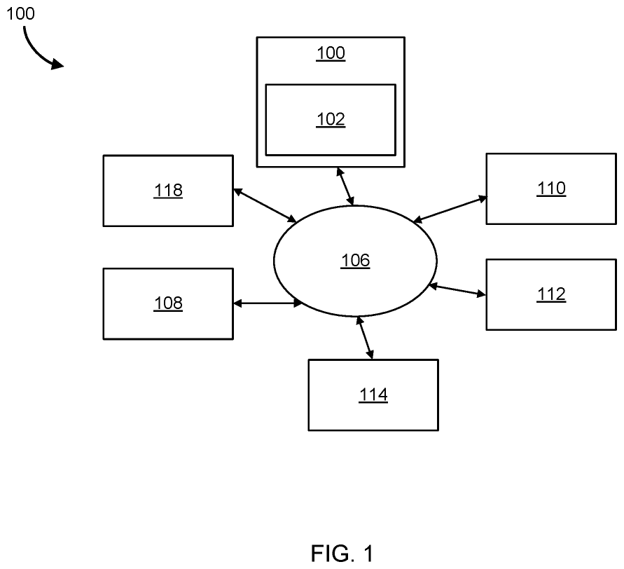

FIG. 1 is a functional block diagram of a data processing environment 100. FIG. 1 provides only an illustration of one implementation and does not imply any limitations with regard to the environments in which different embodiments may be implemented. Many modifications of the depicted environment may be made by those skilled in the art without departing from the scope of the claims. In one or more cases, the data processing environment 100 includes a server 104, which operates a fraud detection system 102 (hereinafter “system 102”), a data storage repository 108, and one or more computing devices, such as computing device 118 and customer devices 110, 112, and 114 coupled over a network 106. The server 104, system 102, data storage repository 108, and devices 110, 112, 114, and 118 can each be any suitable computing device that includes any hardware or hardware and software combination for processing and handling information, and transmitting and receiving data among the server 104, system 102, data storage repository 108, and devices 110, 112, 114, and 118.

The server 104, system 102, data storage repository 108, and devices 110, 112, 114, and 118 can each include one or more processors, one or more field-programmable gate arrays (FPGAs), one or more application-specific integrated circuits (ASICs), one or more state machines, digital circuitry, or any other suitable circuitry.

The network 106 interconnects the server 104, the data storage repository 108, and one or more of the devices 110, 112, 114, and 118. In general, the network 106 can be any combination of connections and protocols capable of supporting communication between the server 104, the data storage repository 108, one or more of the computing devices 110, 112, 114, and 118, and the system 102. For example, the network 106 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. In one or more cases, the network 106 may include wire cables, wireless communication links, fiber optic cables, routers, switches, firewalls, or any combination that can include wired, wireless, or fiber optic connections known by those skilled in the art.

In one or more cases, the server 104 hosts the system 102. In some cases, the server 104 may be a web server, a blade server, a mobile computing device, a laptop computer, a tablet computer, a netbook computer, a personal computer (PC), a desktop computer, or any programmable electronic device or computing system capable of receiving and sending data, via the network 106, and performing computer-readable program instructions. For example, for the cases in which the server 104 is a web server, the server 104 may host one or more pages of a website. Each of the computing devices 110, 112, 114, and 118 may be operable to view, access, and interact with the web pages hosted by the server 104. In one or more examples, the server 104 hosts a website, such as an e-commerce website, for a retailer to sell items and for a customer to purchase an item via one or more web pages. For example, a user of a computing device, such as the computing device 110, 112, or 114, may access a web page, add one or more items to an online shopping cart, and perform an online checkout of the shopping cart to purchase the items. In another example, a user of the computing device 118 may access one or more aspects of the system 102, for instance, to review a transaction, for example, a challenged transaction. In other cases, the server 104 can be a data center, which includes of a collection of networks and servers, such as virtual servers and applications deployed on virtual servers, providing an external party access to the system 102. In some other cases, the server 104 represents a computing system utilizing clustered computers and components (e.g., database server computer, application server computers, etc.) that act as a single pool of seamless resources, such as in a cloud computing environment, when accessed within data processing environment 100.

In one or more cases, the data storage repository 108 may store data including, but not limited to, fraudulent transactions, non-fraudulent transactions, and synthetic fraudulent transactions, entity connections, activity counts, and the like as discussed herein.

In one or more cases, the data storage repository 108 may be one of, a web server, a mobile computing device, a laptop computer, a tablet computer, a netbook computer, a personal computer (PC), a desktop computer, or any programmable electronic device or computing system capable of receiving, storing, sending data, and performing computer readable program instructions capable of communicating with the server 104, computing devices 110, 112, 114, and 118, via network 106. In one or more cases, the data storage repository 108 may represent virtual instances operating on a computing system utilizing clustered computers and components (e.g., database server computer, application server computers, etc.) that act as a single pool of seamless resources when accessed within data processing environment 100. In one or more cases, the data storage repository 108 may be a remote storage device. In one or more other cases, the data storage repository 108 may be a local storage device on the server 104. For example, the data storage repository 108 may be, but not limited to, a hard drive, non-volatile memory, or a USB stick.

In one or more cases, devices 110, 112, 114, and 118 are clients to the server 104. The devices 110, 112, 114, and 118 may be, for example, a desktop computer, a laptop computer, a tablet computer, a personal digital assistant (PDA), a smart phone, a thin client, a voice assistant device, a digital assistant, or any other electronic device or computing system capable of communicating with server 104 through network 102. For example, device 118 may be a desktop computer capable of connecting to the network 106 to review one or more transactions. In another example, the device 114 may be a mobile device capable of connecting to the network 106 and placing an order to purchase an item on the e-commerce website. In one or more cases, one or more of the devices 110, 112, 114, and 118 may be any suitable type of mobile device capable of running mobile applications, including smart phones, tablets, slate, or any type of device that runs a mobile operating system.

In one or more cases, one or more of the devices 110, 112, 114, and 118 includes a user interface for providing an end user with the capability to interact with the system 102. For example, an end user of the computing device 118 may access the system 102 through the user interface to review one or more transactions. A user interface refers to the information (such as graphic, text, and sound) a program presents to a user and the control sequences the user employs to control the program. The user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation. For example, the GUI may allow users to view, access, and interact with a website hosted on the server 104.

In one or more cases, one or more of the devices 110, 112, 114, and 118 can be any wearable electronic device, including wearable electronic devices affixed to, for example but not limited to, eyeglasses and sunglasses, helmets, wristwatches, clothing, and the like, and capable of sending, receiving, and processing data. For example, the device 110 may be a wearable electronic device, such as a wristwatch, capable of accessing an e-commerce website and placing an order to purchase an item from the e-commerce website.

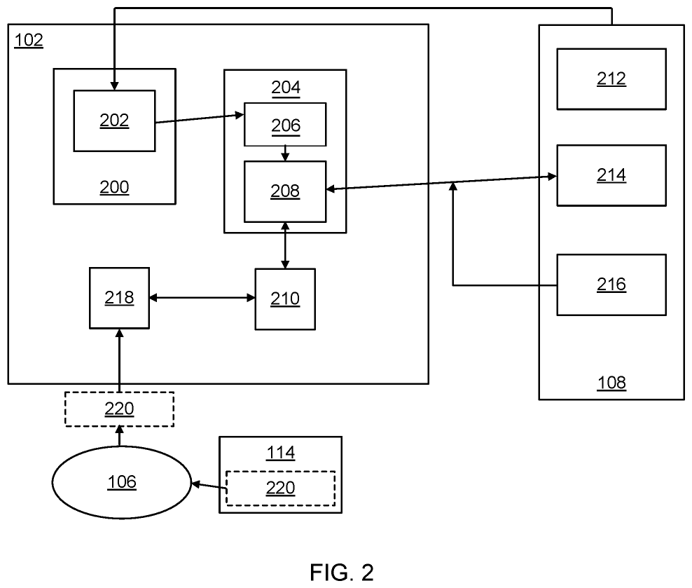

FIG. 2 is a functional block diagram illustrating components of the data processing environment 100 of FIG. 1.

In one or more cases, the data storage repository 108 includes one or more databases for storing information. For example, the data storage repository 108 may include a transaction samples database 212, a graphics database 214, and a metrics database 216. In one or more cases, the transaction samples database 212 may store fraudulent transaction samples, non-fraudulent transaction samples, and/or synthetic fraudulent transaction samples. In one or more cases, a fraudulent transaction sample may be data that indicates a transaction is fraudulent. In one or more cases, a non-fraudulent transaction sample may be data that indicates an accepted transaction, in which the system 102 does not detect fraud. The system 102 may create the synthetic fraudulent transaction samples based on one or more neighboring fraudulent transaction samples.

In one or more cases, the system 102, for example, via model trainer 202, may create one or more synthetic fraudulent transaction samples using an oversampling method, such as, but not limited to, a Synthetic Minority Over-sampling (SMOTE) technique. In one or more cases, the graph database 214 may store entity connections. An entity connection may be, for example, but not limited to, the connection between a customer of the e-commerce website and a device the customer uses to connect to the e-commerce website. In one or more cases, entity connections may be stored in one or more lookup tables within the graph database 214. In one or more cases, the metrics database 216 may store activity counts for one or more customers. An activity count may include, for example, but not limited to, a number of orders from a customer within a period of time, for example, within the last thirty days. It is noted that FIG. 2 illustrates the transaction samples database 212, the graph database 214, and the metrics database 216 as being localized on the data storage repository 108. However, it should be understood that one or more of these databases 212, 214, and 216 may be stored on other repositories that are remote from the data storage repository 108.

In one or more cases, the system 102 includes a model training environment 200, a model deployment environment 204, a model execution engine 210, and a fraud gateway 218. In one or more cases, the model training environment 200 may include a model training engine 202 configured to train a fraud model and an incremental fraud model and store one or both of these models in a model repository 206. In one or more cases, the model deployment environment 204 may include the model repository 206 and a model deployment engine 208. The model repository 206 may store a fraud model, an incremental fraud model, and heuristics for these models. In one or more cases, the model trainer 204 may retrieve one or both of these models to refresh the model based on updated or newly receive transaction samples, as discussed herein. In one or more cases, the model deployment engine 208 may retrieve one or both of these models and deploy the models to the model execution engine 210. It is noted that FIG. 2 illustrates the model repository 206 being stored in the model deployment environment 204; but it should be understood that the model repository 206 may be stored in one or more other repositories, which are remote from the system 102, including, but not limited to, the data storage repository 108.

In one or more cases, the model execution engine 210 may be configured to receive a live transaction, such as transaction 220, via the fraud gateway 218, and apply a deployed fraud transaction model and/or a deployed incremental fraud model to the received transaction, as discussed herein. In one or more cases, the fraud gateway 218 may be an application programming interface that facilitates communication between the system 102, in particular the model execution engine 210, and one or more devices, such as device 114, connected to the network 106.

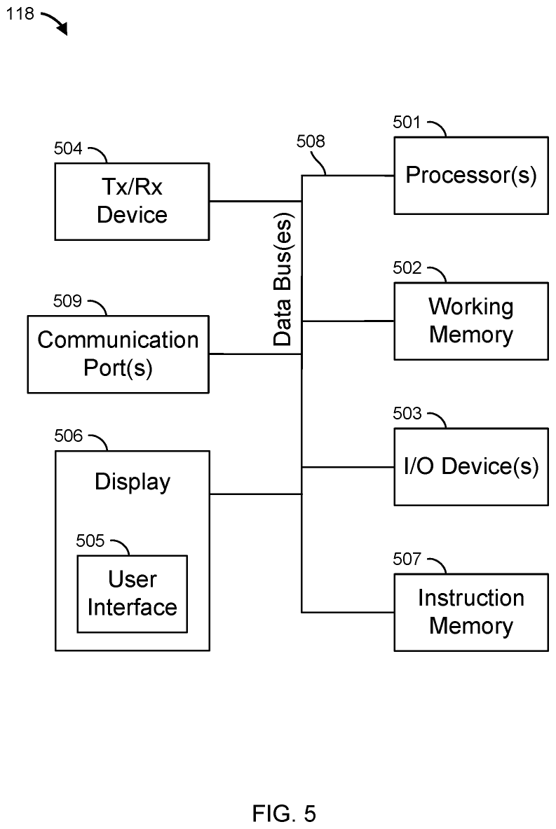

In one or more examples, one or more of the model training engine 202, model deployment engine 208, and the model execution engine 210 may be implemented in hardware. In one or more examples, one or more of the model training engine 202, model deployment engine 208, and the model execution engine 210 may be implemented as an executable program maintained in a tangible, non-transitory memory, such as instruction memory 507 of FIG. 5, which may be executed by one or processors, such as processor 501 of FIG. 5.

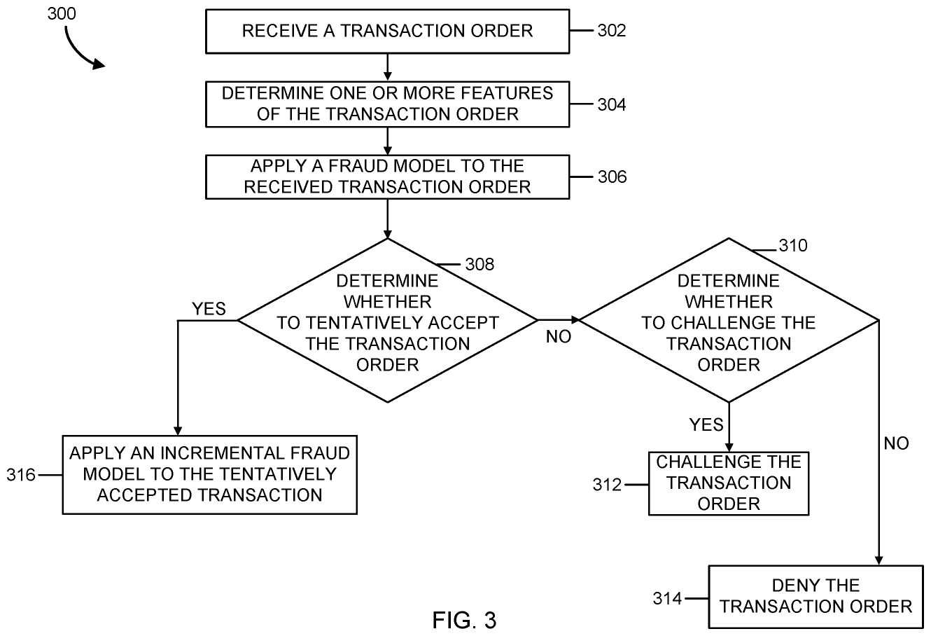

FIG. 3 is a flowchart illustrating a process 300 of identifying fraudulent transactions.

An order for a transaction 220 is received (302), preferably by the system 102. In one or more cases, the system 102, and in particular the model execution engine 210 via the fraud gateway 218, receives the transaction order 220. In one or more examples, the transaction order 220 may be an order that was placed on an e-commerce website to purchase one or more products. For example, a customer may place the transaction order 220 on the e-commerce website, via the computing device 114. The fraud gateway 218 may receive the transaction order 220 from the computing device 114, via the network 106, and may provide the transaction order 220 to the model execution engine 210. It is noted that the example discussed herein with respect to process 300 analyzes whether one transaction order is a fraudulent transaction, but it should be noted that multiple transaction orders may be received, and analyzed as they are received, simultaneously, or iteratively.

One or more features of the transaction order 220 are determined (304), preferably by the model execution engine 210. In one or more cases, having received the transaction order 220, the model execution engine 210 may extract one or more features from the transaction order 220. For example, the model execution engine 210 may extract the name of the customer who placed the transaction order 220, the billing address of the customer, the indicated shipping address for the products within the transaction order 220, and the like. In an example, the model execution engine 210 may receive a first transaction order, and extract a first customer's name, a billing address having a Washington, D.C. zip code, and a shipping address having a Philadelphia zip code, as features for the first transaction order. In another example, the model execution engine 210 may receive a second transaction order, and extract a second customer's name and a billing address and shipping address that refer to a Washington, D.C. zip code, as features for the second transaction order. In one or more cases, by identifying the customer for the transaction order 220, the model execution engine 210 may retrieve one or more entity connections for the customer from the graph database 214, and/or an activity count for the customer from the metrics database 216, as features of the transaction order 220.

A fraud model is applied to the received transaction order 220 (306), preferably by the model execution engine 210, to generate an initial score. In one or more cases, the model execution engine 210 retrieves the fraud model from the model repository 206, via, for example, the model deployment engine 208. In one or more cases, the fraud model may include one or more of a logistic regression model and a boosting model, such as but not limited to, a gradient boosting machine (GBM) model. In one or more cases, the model execution engine 210 applies the fraud model, via for example, the logistic regression model, the GBM model, or both of the logistics regression model and the GBM model, to the one or more determined features of the transaction order 220 and generates results for this transaction order 220. For the cases in which the model execution engine 210 applies a fraud model that includes both the logistic regression model and the GBM model, the model execution engine 210 applies a pseudo stacking technique to combine the results, generated by each of the logistic regression model and the GBM model. Having combined the results for each model, the model execution engine 210 generates an initial score for the transaction order 220.

In one or more cases, the model training engine 202 may train the fraud model using at least non-fraudulent transactions and/or fraudulent transactions in which a chargeback matured within a time period. In one or more cases, the system 102 may consider fraudulent transactions as being positive and non-fraudulent transactions as being negative. In one or more cases, the system 102 may consider a transaction as being false positive, in which the fraud model indicates the transaction is a fraudulent transaction when the transaction is actually a non-fraudulent transaction. In one or more cases, the system 102 may consider a transaction as being a false negative, in which the fraud model indicates to the transaction is non-fraudulent when the transaction is actually a fraudulent case. In one or more examples, a non-fraudulent transaction sample may refer to data indicating that a transaction order was not fraudulent. In one or more examples, a fraudulent transaction sample may refer to data indicating that a customer notified the company of the e-commerce website that the customer did not place the transaction order. A chargeback may mature, in an example, when a customer, who reported a fraudulent transaction, receives the money that was transferred for the fraudulent transaction. In one or more cases, the model training engine 202 collects the false positive transaction samples in which corresponding chargebacks have a matured within the time period, such as within the past five months from when the model training engine 202 trains the fraud model. In one or more cases, the model training engine 202 may train the fraud model offline and retrieve the fraudulent transaction samples and/or the non-fraudulent transaction samples from the transaction samples database 212. The model training engine 202 may store the trained fraud model in the model repository 206. In one or more cases, the model training engine 202 may retrain the fraud model based on the time period, e.g., every five months, in which chargebacks for the fraudulent transaction samples matured.

Having generated an initial score for the transaction order 220, a determination is made (308), preferably by the model execution engine 210, as to whether to tentatively accept the transaction order 220. In one or more cases, the model execution engine 210 may tentatively accept the transaction order 220 based on the initial score being less than a first threshold number. For example, if the initial score is less than a first threshold number of 0.75, then the model execution engine 210 tentatively accepts the transaction order 220.

For the cases in which the model execution engine 210 does not tentatively accept the transaction order 220 (308:NO), a determination is made (310), preferably by the model execution engine 210, as to whether to challenge the transaction order 220. In one or more cases, the model execution engine 210 may challenge the transaction order 220 (312) when the initial score is equal to or greater than the first threshold number (e.g., 0.75) but less than a second threshold number (e.g., 0.9). For example, when the model execution engine 210 applies the fraud detection model to the second transaction order in which the second customer's billing and shipping address correspond to the same address, the model execution engine 210 may generate a score of 0.8 for the second transaction order and challenge the second transaction order. Some example factors that may influence the initial score may include, but are not limited to, a low activity count for the second customer. For the cases in which the model execution engine 210 challenges the transaction order 220, the model execution engine 210 sends the challenged transaction order to a manual review team to further investigate the challenged transaction order. For example, the manual review team may contact the customer to verify the transaction order, verify the customer's location using third party data, and the like.

In one or more cases, the model execution engine 210 may deny the transaction order 220 (314) when the initial score is greater than the second threshold number (e.g., 0.9). For example, when the model execution engine 210 applies the fraud detection model to the first transaction order in which the first customer's billing and shipping address correspond to different addresses, the model execution engine 210 may generate a score of 0.99 for the first transaction order and deny the first transaction order. For the cases in which the model execution engine 210 denies the transaction order 220, the system 102 prevents the transaction order 220 from completing. As such, the company does not receive any money for the transaction order, nor does the company send the one or more products within the transaction order to the customer identified in the transaction order 220.

For the cases in which the model execution engine 210 tentatively accepts the transaction order 220 (308:YES), an incremental fraud model is applied to the tentatively accepted transaction (316) preferably by the model execution engine 210. In one or more cases, the model execution engine 210 retrieves the incremental fraud model from the model repository 206, via, for example, the model deployment engine 208. In one or more cases, the incremental fraud model may include one or both of neural networks or a boosting model, such as but not limited to a GBM model. In one or more cases, the incremental fraud model may primarily use the boosting model, neural networks, or a combination of both the neural networks and the boosting model. In one or more cases, the model execution engine 210 applies the incremental fraud model, via for example, the boosting model, neural networks, or both of the neural networks and the boosting model, to the one or more determined features of the transaction order 220 and generates results. Having combined the results for each model, the model execution engine 210 generates a secondary score for the tentatively accepted transaction order 220.

In one or more cases, the model execution engine 210 may determine whether to accept, deny or challenge the tentatively accepted transaction order 220 based on the generated secondary score. In one or more cases, the model execution engine 210 may accept the transaction order 220 based on the secondary score being less than a fourth threshold number. For example, if the secondary score is less than a fourth threshold number, then the model execution engine 210 accepts the tentatively accepted transaction order 220. In one or more cases, the fourth threshold number may have the same threshold value as the first threshold number. In one or more other cases, the fourth threshold number may have a threshold value that is different from the first threshold number. For the cases in which the model execution engine 210 accepts the tentatively accepted transaction order 220, the system 102 determines that the transaction order 220 is not fraudulent and processes the transaction order 220. By processing the transaction order 220 the company receives money for the transaction order, and sends the one or more products within the transaction order to the customer identified in the transaction order 220.

In one or more cases, the model execution engine 210 may challenge the tentatively accepted transaction order 220 when the secondary score is equal to or greater than the fourth threshold number but less than a fifth threshold number. In one or more cases, the fifth threshold number may have the same threshold value as the second threshold number. In one or more other cases, the fifth threshold number may have a threshold value that is different from the second threshold number. For the cases in which the model execution engine 210 challenges the tentatively accepted transaction order 220, the model execution engine 210 sends the challenged transaction order to a manual review team to further investigate the challenged transaction order, in a same or similar manner as discussed with respect to challenging the transaction order 220 in process 312. In one or more cases, the model execution engine 210 may deny the tentatively accepted transaction order 220 when the secondary score is greater than the fifth threshold number. For the cases in which the model execution engine 210 denies the tentatively accepted transaction order 220, the system 102 determines that the tentatively transaction order is fraudulent and prevents the transaction order 220 from completing.

In one or more cases, the model training engine 202 may train the incremental fraud model using sample data such as, but not limited to, one or more of fraudulent transaction samples in which a chargeback matured within a time period, transaction orders that were denied by the manual review agents, synthetic fraudulent transaction samples, and the like. In one or more cases, the model training engine 202 may collect the fraudulent transaction samples in which a chargeback matured within a time period that is shorter than the time period for collecting the fraudulent transaction samples to train the fraud model. For example, the model training engine 202 may collect the fraudulent transaction samples that matured within the past week or the past two weeks from when the model training engine 202 trains the incremental fraud model.

In one or more cases, the model training engine 202 may create synthetic fraudulent transaction samples based on fraudulent transaction samples stored in the transaction sample database 212. In one or more cases, the model training engine 202 may create synthetic fraudulent transaction samples by applying oversampling method, such as, but not limited to, the SMOTE technique, to the fraudulent transaction samples. By applying the SMOTE technique, the model training engine 202 may create synthetic samples based on neighboring fraudulent transaction samples. Having created the synthetic fraudulent transaction samples, the model training engine 202 may store the synthetic fraudulent transaction samples within the transaction samples database 212.

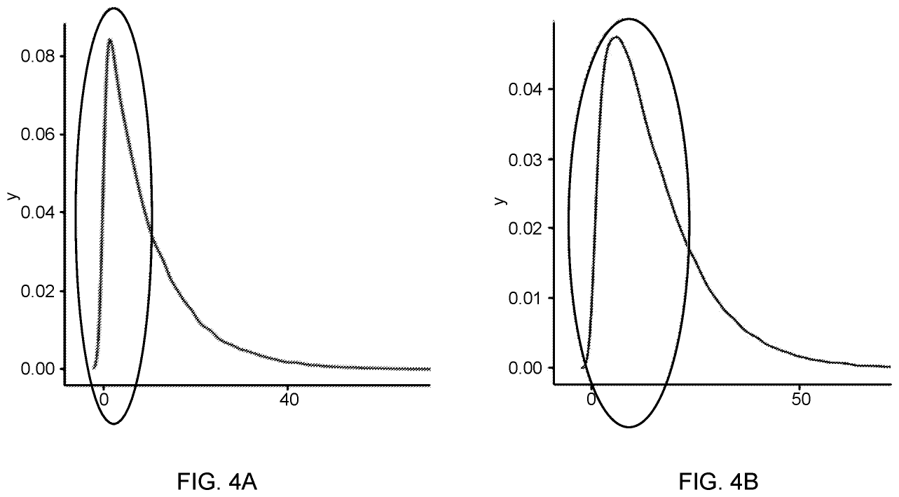

In one or more cases, to train the incremental fraud model, the model training engine 202 may sample the collected sample data over a period of time using a distribution, such as, but not limited to, a gamma distribution in which the sample data decreases in importance as the time period increases. In one or more cases, by determining the distribution of the sample data, the model training engine 202 may determine how relevant the collected sample data is to identifying a fraudulent transaction. For example, FIGS. 4A and 4B illustrate gamma distributions for the collect sample data over increasing time periods. The gamma distribution graphs may be used to compare the collected sample data from one period (e.g., the most recent two weeks) to a previous time period (e.g., the two weeks prior to the most recent two weeks). The x-axis of each graph indicates the most recent sample data collected starting from the left of the graph, and the y-axis of each graph indicates the gamma distribution which is calculated as follows: (1/βαΓ(α))xα−1e−x/β. In view of the gamma distribution over a time period, FIG. 4A illustrates that the collected sample data within the first time period (e.g., the most recent two weeks) is important to identifying fraudulent transactions compared to the sample data collected within the second time period (e.g., the two weeks prior to the most recent two weeks). FIG. 4B illustrates that the collected sample data within the third time period (e.g., the most recent month) is less important (i.e., compared to the gamma distribution shown in FIG. 4A) to identifying fraudulent transactions compared to the sample data collected within the fourth time period (e.g., the month prior to the most recent month). In one or more examples, FIG. 4A illustrates that the most recent example data, e.g., collected in the first time period, is useful in identifying fraudulent transactions, whereas FIG. 4B illustrates that the prior example data, e.g., collected in the third time period, is still useful in identifying fraudulent transactions.

In one or more cases, the model training engine 202 may train the incremental fraud model offline and may retrain the incremental fraud model based on the time period, e.g., within the past week or the past two weeks, in which the chargebacks for the fraudulent transaction samples matured. The model training engine 202 may store the trained incremental fraud model in the model repository 206.

In one or more cases, the process 300 may identify more fraudulent transactions than that of conventional fraud detection systems by identifying fraudulent transaction via the fraud model and the incremental fraud model. By identifying more fraudulent transaction, queues for reviewing challenged transaction orders are relaxed, which in turn provides more time for manual reviewing agents to review challenged transactions. In one or more cases, via the incremental fraud model, the process 300 provides additional review for transactions, which conventional fraud detection systems would have accepted. By applying the additional review, the process 300 may reduce the rate in which false negative transactions occur, thereby improving the accuracy for identifying fraudulent transactions.

FIG. 5 depicts a block diagram of components of a computing device capable of performing the processes described herein. In particular, FIG. 5 illustrates an example computing device, such as computing device 118, capable of interacting with the system 102 of FIG. 1.

Computing device 118 can include one or more processors 501, working memory 502, one or more input/output devices 503, instruction memory 507, a transceiver 504, one or more communication ports 507, and a display 506, all operatively coupled to one or more data buses 508. Data buses 508 allow for communication among the various devices. Data buses 508 can include wired, or wireless, communication channels.

Processors 501 can include one or more distinct processors, each having one or more cores. Each of the distinct processors can have the same or different structure. Processors 501 can include one or more central processing units (CPUs), one or more graphics processing units (GPUs), application specific integrated circuits (ASICs), digital signal processors (DSPs), and the like.

Processors 501 can be configured to perform a certain function or operation by executing code, stored on instruction memory 507, embodying the function or operation. For example, processors 501 can be configured to perform one or more of any function, method, or operation disclosed herein.

Instruction memory 507 can store instructions that can be accessed (e.g., read) and executed by processors 501. For example, instruction memory 507 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 501 can store data to, and read data from, working memory 502. For example, processors 501 can store a working set of instructions to working memory 502, such as instructions loaded from instruction memory 507. Processors 501 can also use working memory 502 to store dynamic data created during the operation of system 102. Working memory 502 can be a random access memory (RAM) such as a static random access memory (SRAM) or dynamic random access memory (DRAM), or any other suitable memory.

Input-output devices 503 can include any suitable device that allows for data input or output. For example, input-output devices 503 can include one or more of a keyboard, a touchpad, a mouse, a stylus, a touchscreen, a physical button, a speaker, a microphone, or any other suitable input or output device.

Communication port(s) 509 can include, for example, a serial port such as a universal asynchronous receiver/transmitter (UART) connection, a Universal Serial Bus (USB) connection, or any other suitable communication port or connection. In some examples, communication port(s) 509 allows for the programming of executable instructions in instruction memory 507. In some examples, communication port(s) 509 allow for the transfer (e.g., uploading or downloading) of data, such as transaction data.

Display 506 can display user interface 505. User interfaces 505 can enable user interaction with, for example, computing device 112 or 118. For example, user interface 505 can be a user interface for an application of a retailer that allows a customer to purchase one or more items from the retailer. In some examples, a user can interact with user interface 505 by engaging input-output devices 503. In some examples, display 506 can be a touchscreen, in which the touchscreen displays the user interface 505.

Transceiver 504 allows for communication with a network, such as the communication network 118 of FIG. 1. For example, if network 106 of FIG. 1 is a cellular network, transceiver 504 is configured to allow communications with the cellular network. In some examples, transceiver 504 is selected based on the type of network 106 system 102 will be operating in. Processor(s) 501 is operable to receive data from, or send data to, a network, such as network 106 of FIG. 1, via transceiver 504.

Although the embodiments discussed herein are described with reference to the figures, it will be appreciated that many other ways of performing the acts associated with the embodiments can be used. For example, the order of some operations may be changed, and some of the operations described may be optional.

In addition, the embodiments described herein can be at least partially implemented in the form of computer-implemented processes and apparatus. The disclosed embodiments may also be at least partially implemented in the form of tangible, non-transitory machine-readable storage media encoded with computer program code. For example, the processes described herein can be implemented in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the embodiments. The embodiments may also be at least partially implemented in the form of a computer into which computer program code is loaded or executed, such that, the computer becomes a special purpose computer for practicing the embodiments. When implemented on a general-purpose processor, the computer program code segments configure the processor to create specific logic circuits. The embodiments may alternatively be at least partially implemented in application specific integrated circuits for performing the embodiments.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A system comprising:
a memory having instructions stored thereon, and a processor configured to read the instructions to:
receive transaction order data for a transaction order;
apply a fraud model to the received transaction order data and generate an initial score;
determine whether to tentatively accept the received transaction order based on the generated initial score being less than a first threshold value;
apply, in response to tentatively accepting the received transaction order, an incremental fraud model to the received transaction order data and generate a second score; and
deny the received transaction order when the second score is greater than a second threshold value.

2. The system of claim 1, wherein the processor is further configured to:
determine feature data of the received transaction order; and
apply the fraud model to the feature data to generate the initial score.

3. The system of claim 1, wherein the processor is further configured to apply the fraud model by applying one or both of a logistic regression model and a boosting model to feature data of the received transaction order.

4. The system of claim 1, wherein the fraud model is trained with non-fraudulent transaction sample data and fraudulent sample data, wherein corresponding chargeback data matured within a first time period,
wherein the incremental fraud model is trained with one or more fraudulent transaction sample data, data corresponding to transaction orders that were manually denied, and synthetic fraudulent data, and
wherein corresponding chargeback data to the one or more fraudulent transaction sample data, data corresponding to transaction orders that were manually denied, and synthetic fraudulent data matured within a second time period, the second time period being a shorter duration of time than the first time period.

5. The system of claim 1, wherein the processor is further configured to, in response to not tentatively accepting the transaction order, determine whether to challenge the received transaction order.

6. The system of claim 5, wherein the processor is further configured to:
challenge the received transaction order when the generated initial score is greater than or equal to the first threshold value; and
deny the received transaction order when the generated initial score is greater than a third threshold value.

7. The system of claim 1, wherein the processor is further configured to:
challenge the received transaction order when the generated second score is greater than or equal to the second threshold value; and
accept the received transaction order when the generated second score is less than a third threshold value.

8. A method comprising:
receiving transaction order data for a transaction order;
applying a fraud model to the received transaction order data and generating an initial score;
determining whether to tentatively accept the received transaction order based on the generated initial score being less than a first threshold value;
applying, in response to tentatively accepting the received transaction order, an incremental fraud model to the received transaction order data and generating a second score; and
denying the received transaction order when the second score is greater than a second threshold value.

9. The method of claim 8, further comprises:
determining feature data of the received transaction order; and
applying the fraud model to the feature data to generate the initial score.

10. The method of claim 8, wherein applying the fraud model comprises applying one or both of a logistic regression model and a boosting model to feature data of the received transaction order.

11. The method of claim 8, wherein the fraud model is trained with non-fraudulent transaction sample data and fraudulent sample data, wherein corresponding chargeback data matured within a first time period,
wherein the incremental fraud model is trained with one or more fraudulent transaction sample data, data corresponding to transaction orders that were manually denied, and synthetic fraudulent data, and
wherein corresponding chargeback data to the one or more fraudulent transaction sample data, data corresponding to transaction orders that were manually denied, and synthetic fraudulent data matured within a second time period, the second time period being a shorter duration of time than the first time period.

12. The method of claim 8, further comprises determining, in response to not tentatively accepting the transaction order, whether to challenge the received transaction order.

13. The method of claim 12, further comprises:
challenging the received transaction order when the generated initial score is greater than or equal to the first threshold value; and
denying the received transaction order when the generated initial score is greater than a third threshold value.

14. The method of claim 8, further comprises:
challenging the received transaction order when the generated second score is greater than or equal to the second threshold value; and
accepting the received transaction order when the generated second score is less than a third threshold value.

15. A computer program product comprising:
a non-transitory computer readable medium having program instructions stored thereon, the program instructions executable by one or more processors, the program instructions comprising:
receiving transaction order data for a transaction order;
applying a fraud model to the received transaction order data and generating an initial score;
determining whether to tentatively accept the received transaction order based on the generated initial score being less than a first threshold value;
applying, in response to tentatively accepting the received transaction order, an incremental fraud model to the received transaction order data and generating a second score; and
denying the received transaction order when the second score is greater than a second threshold value.

16. The computer program product of claim 15, wherein the program instructions further comprise:
determining feature data of the received transaction order; and
applying the fraud model to the feature data to generate the initial score.

17. The computer program product of claim 15, wherein applying the fraud model comprises applying one or both of a logistic regression model and a boosting model to feature data of the received transaction order.

18. The computer program product of claim 15, wherein the fraud model is trained with non-fraudulent transaction sample data and fraudulent sample data, wherein corresponding chargeback data matured within a first time period,
wherein the incremental fraud model is trained with one or more fraudulent transaction sample data, data corresponding to transaction orders that were manually denied, and synthetic fraudulent data, and
wherein corresponding chargeback data to the one or more fraudulent transaction sample data, data corresponding to transaction orders that were manually denied, and synthetic fraudulent data matured within a second time period, the second time period being a shorter duration of time than the first time period.

19. The computer program product of claim 15, wherein the program instructions further comprise:
determining, in response to not tentatively accepting the transaction order, whether to challenge the received transaction order;
challenging the received transaction order when the generated initial score is greater than or equal to the first threshold value; and
denying the received transaction order when the generated initial score is greater than a third threshold value.

20. The computer program product of claim 15, wherein the program instructions further comprise:
challenging the received transaction order when the generated second score is greater than or equal to the second threshold value; and
accepting the received transaction order when the generated second score is less than a third threshold value.
